(19) United States
(12) Patent Application Publication
(10) Pub. No.: US 2025/0106751 A1
(43) Pub. Date: Mar. 27, 2025

(54) DATA TRAFFIC CONTROLLER FOR MOBILE DISTRIBUTED ENTITIES

(71) Applicant: DISH Wireless L.L.C., Englewood, CO (US)

(72) Inventors: Sourabh Gupta, Ashburn, VA (US); Bradly Scott Sullivan, Tifton, GA (US); Ash Khamas, Goffstown, NH (US); Amit Pathania, Great Falls, VA (US); Siddhartha Chenumolu, Englewood, CO (US); Sundeep Goswami, Leesburg, VA (US)

(21) Appl. No.: 18/794,621

(22) Filed: Aug. 5, 2024

Related U.S. Application Data
(60) Provisional application No. 63/585,143, filed on Sep. 25, 2023.

(51) Int. Cl. H04W 48/18

(52) U.S. Cl. CPC H04W 48/18

(57) ABSTRACT

A system for dynamic edge routing of data traffic for a mobile entity having a plurality of applications is provided. An automotive edge router (AER) is located on the mobile entity. The AER is configured to connect to and be in signal communication with a plurality of cellular networks associated with different communication service providers (CSPs), and to receive performance data for each of the plurality of cellular networks. A data traffic controller is in signal communication with the AER via one of the plurality of cellular networks and is configured to receive the performance data for each cellular network from the AER, to dynamically select one of the plurality of cellular networks for each of the applications on the mobile entity based on the performance data, and to transmit a command signal to the AER indicating the selection of one of the plurality of cellular networks for each application.

### CROSS-REFERENCE TO RELATED APPLICATIONS

This application is based on, claims priority to, and incorporates herein by reference in its entirety U.S. Ser. No. 63/585,143 filed Sep. 25, 2023, and entitled “Data Traffic Controller For Mobile Distributed Entities.”

### FIELD

The present disclosure relates generally to mobile wireless communication networks and, more particularly, systems and methods for dynamic edge routing of data traffic for a mobile entity such as, for example, a fleet vehicle.

### BACKGROUND

Fleet management systems can utilize wireless communication networks to exchange data and information with and mange an in-motion fleet, for example, a fleet of vehicles such as delivery vehicles (e.g., trucks or vans), taxis and other transportation service vehicles, police vehicles, etc. Existing solutions for fleer management connectivity to each fleet vehicle and a connectivity device implemented on the fleet vehicle typically use static connectivity configurations of the best available connectivity for each deployment. For example, current fleet management connectivity solutions can use static cellular connection mapping within geographic locations (i.e., based on coverage area). However, there is no current ability to automatically and seamlessly switch to alternative carriers or access methods when there are issues with, or failures in, the primary access method. Typically, a fleet vehicle only connects to one cellular connection (associated with a particular communication services provider (CSP) or carrier) at a time, and any additional cellular connections available to the fleet vehicle, for example, provided by different CSPs, are used for back-up only, and manual intervention can be required to switch the connectivity provider. Additional cellular connections may be provided using, for example, an SD-WAN (software-defined wide area network) and/or a mobile device with dual SIM (subscriber identity module) cards. However, these solutions are typically configured to switch carriers (and cellular networks) based on coverage area only and assume that the signal of the cellular connection with the best cellular coverage will provide the best performance.

### SUMMARY

In accordance with an embodiment, a system for dynamic edge routing of data traffic for a mobile entity having an automotive edge router and a plurality of applications includes a memory that stores one or more computer readable media that include instructions, and one or more processor devices. The one or more processor devices configured to execute the instructions of the computer readable media to: receive performance data for a plurality of cellular networks from the automotive edge router, select one of the plurality of cellular networks for each application of the plurality of applications on the mobile entity based on the performance data for the plurality of cellular networks, and transmit a command signal to the automotive edge router indicating the selection of one of the plurality of cellular networks for each application of the plurality of applications.

In accordance with another embodiment, a method for dynamic edge routing of data traffic for a mobile entity having an automotive edge router and a plurality of applications includes receiving, using a data traffic controller, performance data for a plurality of cellular networks, identifying, using the data traffic controller, a priority for each application of the plurality of applications of the mobile entity, selecting, using the data traffic controller, a cellular network from the plurality of cellular networks for each application of the plurality of applications based on the performance data, and transmitting, using the data traffic controller, a command signal to the automotive edge router indicating the selection of one of the plurality of cellular networks for each application of the plurality of applications.

In accordance with another embodiment, an automotive edge router for dynamic edge routing of data traffic for a mobile entity having a plurality of applications includes a transceiver configured to transmit and receive signals, and one or more processor devices coupled to the transceiver and configured to connect to and be in signal communication with a plurality of cellular networks, to receive performance data for each of the plurality of cellular networks, to transmit the performance data for each of the plurality of cellular networks to a data traffic controller via one of the plurality of cellular networks, to receive a command signal from the data traffic controller indicating a selection of one of the plurality of cellular networks for each application that is based on the performance data, and to simultaneously transmit information from each application over the cellular network selected for each application.

### BRIEF DESCRIPTION OF THE DRAWINGS

The present disclosure will hereafter be described with reference to the accompanying drawings, wherein like reference numerals denote like elements.

FIG. 1 is a block diagram of a system for dynamic edge routing of data traffic for a mobile entity in accordance with an embodiment;

FIG. 2 is a block diagram of an example automotive edge router (AER) in accordance with an embodiment;

FIG. 3 illustrates a method for dynamic edge routing of data traffic for a mobile entity in accordance with an embodiment;

FIG. 4 illustrates a method for providing dynamic analytics for a plurality of cellular networks associated with a mobile entity in accordance with an embodiment; and

FIG. 5 is a block diagram of an example computer system in accordance with an embodiment.

### DETAILED DESCRIPTION

The present disclosure describes a system and method for dynamic edge routing of data traffic for a mobile entity. In some embodiments, the system for dynamic edge routing of data traffic for a mobile entity can include an automotive edge router (AER) that can be located (or installed) on the mobile entity (e.g., a fleet vehicle, drone, automated driving vehicle, etc.) and a data traffic controller (DTC) in communication with the AER, for example, via a cellular network. The AER can be configured to connect to and communicate with a plurality of cellular networks where each of the cellular networks can be associated with a different communications service provider (CSP) or carrier. The AER can also provide performance data regarding each cellular network and data regarding one or more applications performed on the mobile entity on which the AER is located to the DTC. In some embodiments, the AER can transmit or stream the performance data and other data to the DTC in real-time or substantially real-time over one of the cellular networks. For example, the AER can transmit or stream the performance data automatically and continuously using a push-based mechanism (e.g., streaming telemetry). In some embodiments, the performance data for each cellular network can include, for example, signal strength, network congestion, latency, data volume allowed with uplink and downlink, jitter, delay, type of radio access technology (e.g., 4G, 5G, WiFi, Satellite, Private cellular), etc. The DTC can be configured to dynamically monitor and analyze the performance data in real-time to select a cellular network for each application for the transmission of information and data from the application. In some embodiments, the information and data from an application may be transmitted over the selected cellular network to, for example, a fleet management system. The DTC can send a command signal to the AER to indicate a selected cellular network for each application. The DTC can advantageously dynamically select a cellular network and CSP for an application based on the performance data; for example, the DTC can select the best cellular network and CSP for the application at a point in time. In some embodiments, the AER can be connected to each of the plurality of cellular networks simultaneously and each cellular network can simultaneously communicate data and information from at least one of the applications. Accordingly, the system can support simultaneous transmission and reception on more than one cellular network and can provide an always-on management plane for data traffic policy management of the AER. The disclosed AER and DTC provide an intelligent dynamic edge access system that enables dynamic traffic steering across multiple cellular networks to be used simultaneously, maximizes connection availability, and prioritizes data traffic appropriately over the best-suited cellular network (and CSP) at all times.

In some embodiments, the system for dynamic edge routing of data traffic for a mobile entity can include an AER located on a mobile entity (e.g., a fleet vehicle) that includes a plurality of applications. The AER can be configured to connect to and be in signal communication with a plurality of cellular networks and to receive performance data for each of the plurality of cellular networks. Each cellular network can be associated with a different CSP. The system can also include a DTC that is in signal communication with the AER via one of the plurality of cellular networks. The DTC can be configured to receive performance data for each cellular network from the AER and the DTC can use the performance data to dynamically select and dynamically maintain each of the plurality of cellular networks for each of the applications on the mobile entity based on the performance data. The DTC can also prioritize the plurality of cellular networks to map each application to the best match CSP.

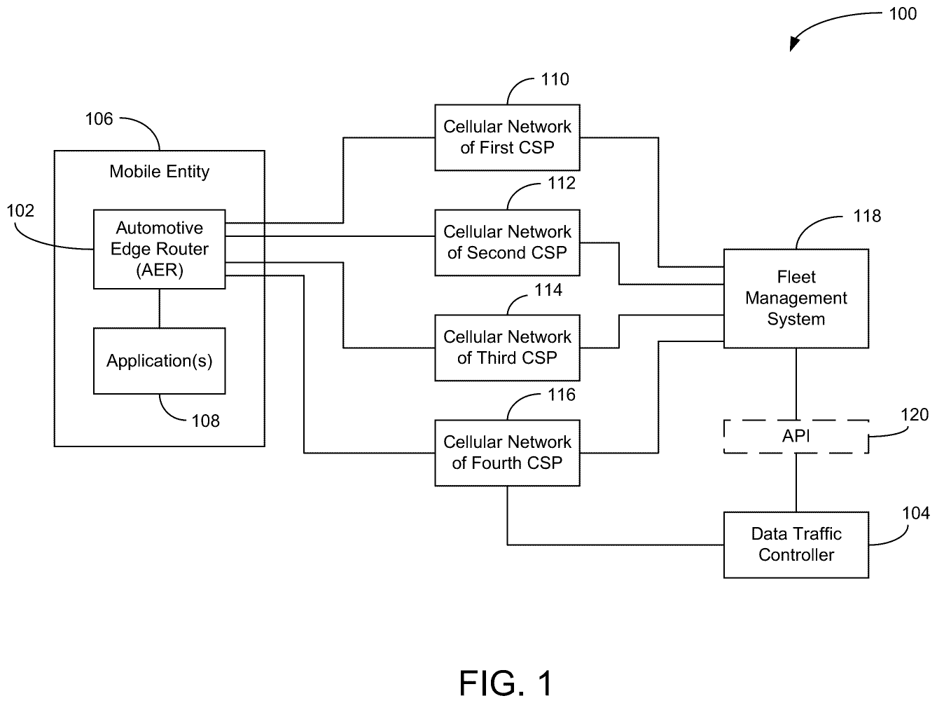

FIG. 1 is a block diagram of a system for dynamic edge routing of data traffic for a mobile entity in accordance with an embodiment. The system 100 can include an AER 102 and a DTC 104. The AER 102 may be located (or installed) on a mobile entity 106 (e.g., a fleet vehicle) that requires a connection to a mobile communication network. A fleet vehicle can include, for example, a delivery vehicle (e.g., a truck or van), taxis or other transportation service vehicles, police vehicles, drones, automatic driving vehicles, etc. While the following description of FIGS. 1-5 may refer to embodiments where the mobile entity 106 is a fleet vehicle, it should be understood that the systems and methods described herein may be utilized for dynamic data traffic routing and control for other mobile entities. In addition, while FIG. 1 illustrates various components of system 100, other embodiments of system 100 can vary the arrangement, communication paths, and specific components of system 100.

In the system 100 illustrated in FIG. 1, the mobile entity 106 can include the AER 102 and one or more applications 108 that may detect, acquire or generate information and data that may be transmitted via the AER 102 to a mobile communications network. Each of the applications 108 may include hardware (e.g., processors, sensors, cameras, microphones, receivers, transmitters, other circuitry or components, and/or combinations thereof), software (e.g., instructions executable by a processor to perform one or more functions of the application), or combinations thereof. For example, the applications 108 and the information provided by the applications 108 may include a video application including a video camera (e.g., for surveillance and security) that generates video data (e.g., a video with or without corresponding audio), a two-way communication application (e.g., for vehicle-to-vehicle communication systems), an audio application including a microphone that generates audio information, an asset reconciliation application that provides asset reconciliation data, a driver monitoring application (e.g., that includes sensors, cameras, audio, etc. and analysis software to monitor a driver), a telemetry application (e.g., to generate and transmit sensor data), a location application that generates location data (e.g., global positioning satellite (GPS) data for the mobile entity), an asset management application, a vehicle monitoring application including vehicle sensor devices (e.g., a sensor to determine if the vehicle is in maintenance mode, infrared cameras, radar, LIDAR, vehicle diagnostic sensors, etc.) to generate and transmit vehicle data, or other applications that can be used to provide intelligence. In some embodiments, if the mobile entity 106 is a delivery vehicle, an asset management application of the applications 108 can include scanning devices (e.g., a bar code, QR code, or image scanner) that may be used to scan packages (e.g., barcode or other symbols) to be delivered, generating scanning data (e.g., indicative of a package identifier and/or package delivery status). The asset management application of the applications 108 may further include corresponding software to facilitate delivery and package tracking based on the scanning data.

The AER 102 can be configured to provide multi-CSP connectivity and Wi-Fi; namely, the AER 102 can connect to a plurality of cellular networks. In some embodiments, each cellular network can be associated with a different CSP or carrier. For example, as illustrated in FIG. 1, AER 102 can connect to and communicate with a cellular network 110 of a first CSP, a cellular network 112 of a second CSP, a cellular network 114 of a third CSP, and a cellular network 116 of a fourth CSP. While four cellular networks 110, 112, 114 and 116 are shown in FIG. 1, it should be understood that in some embodiments, the AER 102 may be configured to connect to other numbers, N, of cellular networks associated with N different CSPs. In some embodiments, cellular networks 110, 112, 114, and 116 can be any suitable cellular network or a combination of cellular networks. In some embodiments, each cellular network 110, 112, 114, and 116 may utilize a radio access technology such as, for example, a 4G Long Term Evolution (LTE) network, a fifth generation (5G) new radio (NR) standalone network, or future technology releases such as 6G, etc. In some embodiments, each cellular network 110, 112, 114, 116 may be a wide area network (WAN), a software-defined wide area network (SD-WAN), etc. In some embodiments, two or more of the cellular networks may be associated with the same CSP (not shown) but represent different slices of the cellular network of the CSP. For example, each cellular network associated with the same CSP may have a different Quality of Service (QOS) as defined by different service level agreements (SLAs). In some embodiments, two or more of the cellular networks may be associated with the same CSP (not shown) but have different radio access technologies, for example, a 4G LTE cellular network and a 5G cellular network. In some embodiments, the AER 102 can transmit data from one or more of the applications 108 (e.g., video data, GPS data, scanning data, etc.) to a fleet management system 118 via one or more of the cellular networks 110, 112, 114 and 116. In addition, as discussed further below, the AER 102 can transmit data to and receive data from the DTC 104 via one of the cellular networks, for example, cellular network 116. While only one mobile entity 106 is shown in FIG. 1, it should be understood that in some embodiments, a plurality of mobile entities 106, each with an AER 102 and application(s) 108, can be in communication with the DTC 104 and the fleet management system 118 via one or more of the cellular networks 110, 112, 114, 116.

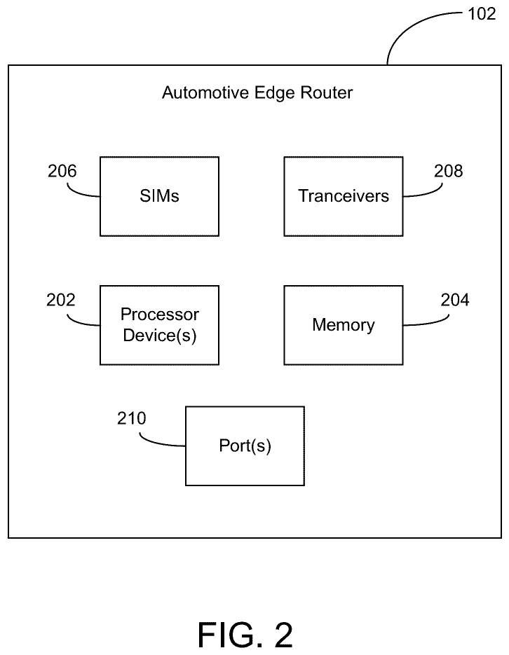

FIG. 2 is a block diagram of an example AER 102 in accordance with an embodiment. AER 102 can include one or more processor devices 202, a memory 204, a plurality of subscriber identity modules (SIMs) 206, a plurality of transceivers 208 and one or more port(s) 210. In some embodiments, the AER is implemented as customer premises equipment (CPE), for example, a universal CPE (uCPE). For example, as mentioned above with respect to FIG. 1, the AER 102 may be located (or installed) on a mobile entity 106 (e.g., a fleet vehicle). In some embodiments, where the AER 102 is located in a vehicle, the AER 102 can be a rugged automotive-grade device that meets automotive standards for compliance and reliability. In some embodiments, the plurality of transceivers 208 can include a separate transceiver for each cellular network (e.g., associated with a different CSP, a different network slice of a CSP, or a different radio access technology of a CSP) to which the AER 102 can connect. For example, the AER 102 may include four transceivers to communicate with four different cellular networks (e.g., cellular networks 110, 112, 114, and 116 shown in FIG. 1). Accordingly, AER 102 can include N transceivers to communicate with N different cellular networks. Each transceiver 208 can transmit and receive signals over one of the cellular networks (e.g., cellular networks 110, 112, 114, and 116 shown in FIG. 1). In some embodiments, the plurality of SIMs 206 can include a separate SIM for each cellular network (e.g., associated with a different CSP, a different network slice of a CSP, or a different radio access technology of a CSP) to which the AER 102 can connect. For example, the AER 102 may include four SIMs to connect with four different cellular networks (e.g., cellular networks 110, 112, 114, and 116 shown in FIG. 1). Accordingly, AER 102 can include N SIMs to connect with N different cellular networks. Each SIM 206 can be used to access a corresponding cellular network associated with a particular CSP. In some embodiments, the SIMS 206 may be physical SIM cards or may be embedded SIM (eSIM) cards. The memory 204 can include one or more non-transitory computer readable media that store software instructions (e.g., for establishing a connection with one or more cellular networks) and data. The processor device(s) 202 can execute the instructions stored on the one or more non-transitory computer-readable media of the memory 204. For example, executing the software instructions can cause the AER 102 to perform various AER operations as described herein. AER 102 may also include one or more physical or wired ports 210 that may be used to couple to and communicate with other components of the mobile entity (e.g., mobile entity 106 shown in FIG. 1) in which the AER 102 is installed. For example, ports 210 may be used to connect the AER 102 to components for the various applications 108 (shown in FIG. 1) of the mobile entity 106. In an example for a fleet vehicle, one of the ports 210 may be connected to a video camera, one of the ports 210 may be connected to a GPS system, one of the ports 210 can be connected to a scanning device, and so on.

Returning to FIG. 1, the AER 102 can be configured to receive performance data from each cellular network 110, 112, 114, 116 and, in some embodiments, performance data related to the application(s) 108. In some embodiments, the performance data for each cellular network can include, for example, signal strength (coverage), network congestion, latency, data volume allowed uplink and downlink, jitter, delay, type of radio access technology (e.g., 4G, 5G), etc. Advantageously, performance data can be received by the AER 102 from each cellular network 110, 112, 114, and 116 in real-time or substantially real-time. The performance data for each application(s) 108 can include, for example, how much data will be transmitted, what bandwidth is requested, etc. The performance data for each application(s) 108 can be provided by the respective application(s) 108 to the AER 102. In some embodiments, AER 102 can transmit the performance data to the DTC 104, for example, continuously and in real-time, via one of the cellular networks 110, 112, 114, 116 supported by the AER 102. For example, in FIG. 1, the AER 102 is illustrated as being in communication with the DTC 104 via the cellular network 116 associated with the fourth CSP. While FIG. 1 illustrates the AER 102 in communication with the DTC 104 over cellular network 116, any of the other cellular networks (e.g., cellular networks 110, 112, and 114) supported by the AER 102 may be used to provide communication between the AER 102 and the DTC 104. In some embodiments, the AER 102 can transmit the performance data of each cellular network to the DTC 104 automatically and continuously, for example, using a push-based mechanism (e.g., streaming telemetry), and via the cellular network 116.

The DTC 104 can be configured to analyze the performance data for the plurality of cellular networks 110, 112, 114, 116 received from the AER 102 and determine or select one of the cellular networks 110, 112, 114, 116 for each application 108 of the mobile entity 106, for example, a fleet truck. For example, in some embodiments, the DTC 104 can determine whether to dynamically reprovision the AER 102 to route or steer data traffic differently based on the analysis of the performance data. In some embodiments, an application 108 may generate more than one type of data stream, for example, sensor data, video, audio, location data, etc. The DTC 104 can also be configured to determine or select one of the cellular networks 110, 112, 114, 116 for each data stream of a particular application 108.

In some embodiments, the analysis of the performance data may be performed using a machine learning model. For example, the performance data of the plurality of cellular networks may be provided to the machine learning model, which can be trained to classify each cellular network 110, 112, 114, 116 to characterize the connectivity status and performance of each cellular network 110, 112, 114, 116 such as, for example, best, better, good, poor, and best effort. The DTC 104 may then have a set of predetermined rules to apply to select a particular one of the cellular networks 110, 112, 114, 116 to use for an application 108 or for a type f data stream of an application 108 based on the characterization (or classification) of the machine learning model. For example, the DTC 104 may select the cellular network with the highest rated classification (e.g., best being above better, which is above good, which is above poor, etc.), or the cellular network with a rating above a certain threshold (e.g., good) and in combination with a lowest associated cost or other preference criteria of the DTC 104. Additionally or alternatively, the performance data of the plurality of cellular networks may be provided to the machine learning model, which can be trained to identify or select one of the available cellular networks (e.g., cellular network 110, 112, 114, or 116) based on the performance data to achieve a desired performance level or satisfy other criteria (e.g., whether specified in or inferred from training data).

The machine learning model used by the DTC 104 for analysis of the performance data can be, for example, decision tree learning (e.g., decision tree learning prescribed by a desired policy of configuration provided by a user or operator), association rule learning, an artificial neural network (e.g., a convolutional neural network, a generative adversarial network), inductive logic programming, support vector machine, clustering, Bayesian network, reinforcement learning, representation learning, similarity and metric learning, sparse dictionary learning, and genetic algorithms. The machine learning model can be trained using known methods such as supervised learning, self-supervised learning, semi-supervised learning, etc. As one example, to perform supervised learning, the training data includes example inputs and corresponding desired (for example, actual) outputs, and the machine learning model progressively develops a model that maps inputs to the outputs included in the training data. As another example, to perform self-supervised learning, a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data).

In some embodiments, the DTC 104 can also identify the priority of each application 108. In some embodiments, the priority for an application 108 can be based on the type of data or type of communication (e.g., critical data versus non-critical data). In some embodiments, the DTC 104 can identify a priority for each application 108 based on a policy predetermined for the fleet management system 118. In some embodiments, the policy predetermined by the fleet management system 118 may include an indication of preferred cellular networks if multiple cellular networks operate at the same baseline performance. In an example, each application may be associated with a priority selected from a plurality of potential priority levels (e.g., low, medium, high, a numerical ranking, etc.). The identified priority for each application 108 can also be considered by the DTC 104 in addition to the performance data to determine or select a cellular network for each application 108. The DTC 104 can send a command signal to the AER 102 to indicate the selected cellular networks for each application 108. Accordingly, the DTC 104 can tell the AER 102 which cellular network from the plurality of cellular networks 110, 112, 114, 116 to select for each application 108 based on the performance data. In some embodiments, at any point during data transmission, the DTC 104 can tell the AER 102 to redirect traffic based on what CSP is providing the best or optimal connectivity for each application at a point in time.

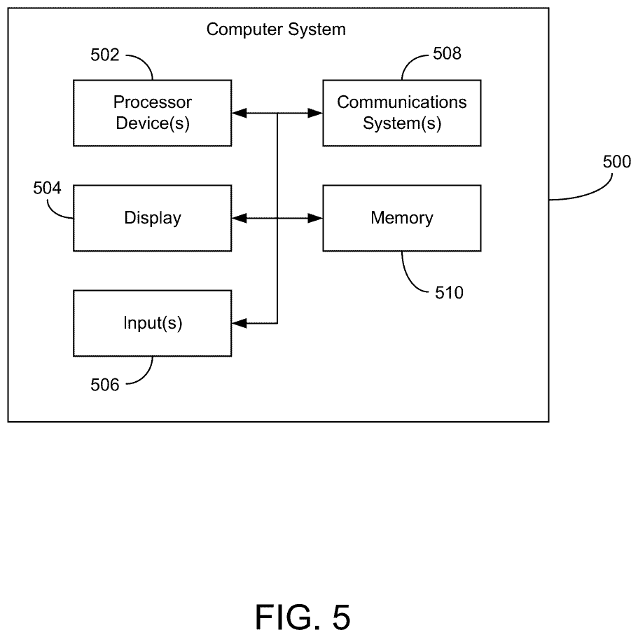

The DTC 104 can advantageously distribute or steer traffic and load across the cellular networks 110, 112, 114, 116 dynamically based on at minimum, the performance data for each cellular network 110, 112, 114, 116 supported by the AER 102. In some embodiments, if all the cellular networks 110, 112, 114, 116 are operable and meet service level agreements (SLAs) or defined key performance indicators (KPIs), all four of the cellular networks 110, 112, 114, 115 may be in use simultaneously at any given time. The DTC 104 advantageously provides an on-demand data traffic controller that can manage an AER 102 (e.g., each AER 102 in a fleet) and provide dynamic policies to the AER 102. Advantageously, in some embodiments, the DTC 104 can make routing and data traffic steering decisions automatically with no manual intervention. In some embodiments, one DTC 104 may be used to control data traffic for each of a plurality of mobile entities 106 (e.g., fleet vehicles) in a fleet. In some embodiments, the DTC 104 may be implemented on a computer system (e.g., computer system 500 discussed below with respect to FIG. 5) such as a server or the functionality of the DTC 104 may be distributed among multiple servers or devices (e.g., as part of a cloud service or cloud-computing environment).

In some embodiments, the DTC 104 may also be configured to generate analytics based on the performance data for each cellular network 110, 112, 114, 116. An optional interface, for example, an application programming interface (API) 120 may be provided to allow an operator of the fleet management system 118 to access and view the performance data and generated analytics of the DTC 104. In some embodiments, the performance data and the generated analytics can be associated with identifying information such as, for example, time stamps, location of the mobile entity 106 when the data was generated, identifier of the mobile entity 106, etc. The fleet management system 118 may be implemented on a computer system (e.g., computer system 500 discussed below with respect to FIG. 5) such as, for example, a server, or the functionality of the fleet management system 118 may be distributed among multiple servers or devices (e.g., as part of a cloud service or cloud-computing environment). In an example, an operator of the fleet management system 118 may view the API 120 on a display the computer system. In some embodiments, an operator of the fleet management system 118 may use the performance data and analytics to, for example, evaluate the service provided by a CSP or for fleet route planning. In an example, an operator of the fleet management system 118 can use the performance data and analytics accessible from the DTC 104 to understand the performance of the fleet vehicles (e.g., is the connectivity in a first fleet vehicle working versus the connectivity in a second fleet vehicle), and what cellular network 110, 112, 114, or 116 is providing consistently the best connectivity and performance. In some embodiments, the analytics can include dashboards, usage metrics, fault and log data, etc. In some embodiments, over time the DTC 104 can leverage the data collected and apply machine learning (e.g., using one of various types of machine learning models discussed above) for advanced automated route planning based on the Day, Week, and Year statistical data across CSPs. For example, the Day, Week, and Year statistical data for the plurality of cellular networks may be provided as input to a machine learning model which can be trained to classify each cellular network to characterize the performance of each cellular network 110, 112, 114, 116 such as, for example, best, better, good, and best effort to define base policies with the predictive analytics proactively. In some embodiments, the API 120 may be implemented on a computer system (e.g., computer system 500 discussed below with respect to FIG. 5) such as, for example, a server.

In some embodiments, the DTC 104 can be configured to receive data and information from the fleet management system 118 using, for example, the API 120. In one example, an operator of the fleet management system 118 may provide an initial policy (or configuration) for the AER 102 for the distribution of traffic across the cellular networks 110, 112, 114, 116 to the DTC 102 via the API 120. In some embodiments, the DTC 104 can advantageously translate or convert the initial policy provided by the operator into programmable network code maintained by the DTC 104. In some embodiments, the DTC 104 can provide the initial policy provided by the operator of the fleet management system 118 to the AER 102, for example, at initial activation of the AER 102. Accordingly, an operator of the fleet management system 118 can define a base policy for the distribution of traffic that can be updated by the DTC 104, for example, based on performance data of the cellular networks 110, 112, 114, 116 as described above. In another example, an operator of the fleet management system 118 can define and provide a policy for distribution of traffic across the cellular networks 110, 112, 114, and 116 to the DTC 104 in real-time during operation of the AER 102 (e.g., in response to an unplanned event that may affect a planned route (e.g., traffic congestion) of the mobile entity 106 as well as the connectivity of the cellular networks 110, 112, 114, 116, an operator of a fleet management system 118 can provide an updated route for the mobile entity 106 that can include an updated policy (or configuration) for the AER 102 for the distribution of traffic across the cellular networks 110, 112, 114, 16). In yet another example, an operator of the fleet management system 118 can provide a priority for each application 108 of the AER 102 (e.g., as part of a predetermined policy for the fleet management system 118 mentioned above) to the DTC 104 using the API 120.

In some embodiments, the DTC 104 can be configured to receive data and information from an operator of a mobile entity 106 (e.g., a driver) or an application 108 on the mobile entity 106 regarding a desired policy (or configuration) for the AER 102 for the distribution of traffic across the cellular networks 110, 112, 114, 116. In some embodiments, an operator of the mobile entity 106 or an application 108 on the mobile entity 106 can define and provide a policy for distribution of traffic across the cellular networks 110, 112, 114, and 116 to the DTC 104 in real- time during operation of the AER 102. In an example, if an operator of the mobile entity 106 or an application 108 itself determines that the application 108 is experiencing a slow response or other performance issues, the operator or application 108 can provide a request for a policy update or provide a policy to the DTC 104 for distribution of traffic across the cellular networks 110, 112, 114, 116. In another example, the mobile entity 106 can include a surveillance and security application that, when it detects suspicious activity, can transmit a request to the DTC 104 to redirect data (e.g., video) from the surveillance and security application to a cellular network 110, 112, 114, 116 with a higher rated classification (e.g., from better to best), shut down all other data traffic from the AER 102 over the selected cellular network 110, 112, 114, 116, store data from one or more other applications 108 locally as needed, and notify the authorities. As mentioned above, the DTC 104 can be configured to translate or convert the policy requests received from the operator of the mobile entity 106 or an application 108 on the mobile entity 106 into programmable network code maintained by the DTC 104.

As mentioned, an operator of the fleet management system 118 or an operator of the mobile entity 106 can provide a policy (or configuration) for the AER 102 for the distribution of traffic across the cellular networks 110, 112, 114, 116 to the DTC 104. In some embodiments, an operator can provide or define the policy using natural language. For example, the API 120 or an input device on the mobile entity 106 can be configured to allow an operator to describe a desired policy using natural language, e.g., via text or speech. The DTC 104 can advantageously include a machine learning model, for example a natural language processing (NLP) neural network, that can be configured to translate the policy received from an operator via natural language into a configuration policy, for example, in the programmable network code maintained by the DTC 104. In some embodiments, an NLP neural network can be implemented as, for example, an artificial neural network (ANN). The NLP neural network can be trained using known methods such as, for example, supervised learning, backpropagation, self-supervised learning, semi-supervised learning, etc.

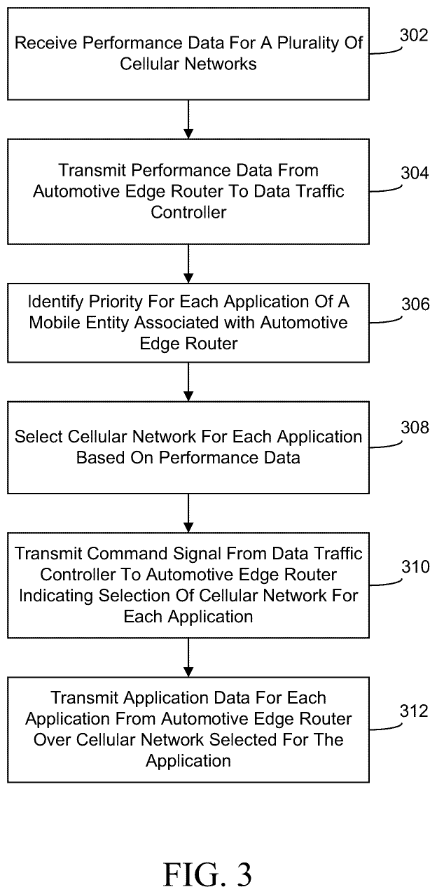

FIG. 3 illustrates a method for dynamic edge routing of data traffic for a mobile entity in accordance with an embodiment. The process illustrated in FIG. 3 is described as being carried out by the system 100 illustrated in FIG. 1, however, in some examples, the process of FIG. 3 may be implemented by another system. Although the blocks of the process are illustrated in a particular order, in some embodiments, one or more blocks may be executed in a different order than illustrated in FIG. 3, or may be bypassed.

At block 302, an AER 102 can receive performance data for a plurality of cellular networks (e.g., cellular networks 110, 112,114, 116) connected to and in communication with the AER 102. For example, as discussed above, (the AER 102 can be configured to provide multi-CSP connectivity; namely, the AER 102 can connect to a plurality of cellular networks 110, 112, 114, 116, where each cellular network is associated with a different CSP or carrier. As also described above, in some embodiments, the AER 102 can connect to a plurality of cellular networks where each cellular network is associated with a different CSP, a different network slice of a CSP, or a different radio access technology of a CSP. The AER 102 can be configured to receive performance data from each cellular network 110, 112, 114, 116. In some embodiments, the performance data for each cellular network can include, for example, signal strength (coverage), network congestion, latency, data volume allowed uplink and downlink, jitter, delay, type of radio access technology (e.g., 4G, 5G), etc. Advantageously, performance data can be received by the AER 102 from each cellular network 110, 112, 114, and 116 in real-time or substantially real-time.

At block 304, the AER 102 can transmit the performance data for each cellular network 110, 112, 114, 116 to a DTC 104 using, for example, one of the cellular networks 110, 112, 113, 116 connected to the AER 102. In some embodiments, the AER 102 can transmit the performance data to the DTC 104 continuously and in real-time. As mentioned above, in some embodiments, the AER 102 can transmit the performance data of each cellular network to the DTC 104 automatically and continuously, for example, using a push-based mechanism (e.g., streaming telemetry), and via one of the cellular networks 110, 112, 114, 116. For example, the AER 102 can transmit performance data for each cellular network 110, 112, 114, 116 to the DTC 104 over the cellular network 116.

At block 306, the DTC 104 can identify a priority for each application 108 of a mobile entity 106 (e.g., a fleet vehicle) associated with the AER 102. As mentioned above, the applications 108 can include, for example, a video application, a two-way communication application, an audio application, an asset reconciliation application, a driver monitoring application, a telemetry application, a location application, an asset management application, a vehicle monitoring application, or other applications that can be used to provide intelligence. In some embodiments, the priority for an application 108 can be based on the type of data or type of communication (e.g., critical data versus non-critical data). In some embodiments, the DTC 104 can identify a priority for each application 108 based on a policy predetermined for a fleet management system 118. In some embodiments, the policy predetermined by the fleet management system 118 may include an indication of preferred cellular networks if multiple cellular networks operate at the same baseline performance. As mentioned above, in an example, each application may be associated with a priority selected from a plurality of potential priority levels (e.g., low, medium, high, a numerical ranking, etc.).

At block 308, the DTC 104 can analyze the performance data to select a cellular network (from the plurality of cellular networks 110, 112, 114, 116 connected to the AER 102) for each application 108 of the mobile entity 106. For example, in some embodiments, the DTC 104 can determine whether to dynamically reprovision the AER 102 to route or steer data traffic differently based on the analysis of the performance data. For example, for each application 108 the DTC 104 may apply a set of predetermined rules and/or thresholds to rank the plurality of cellular networks 110, 112, 114, 116 in order of preference, and select a cellular network for the application based on the preference rankings (e.g., the highest ranked cellular network). Additionally, or alternatively, as discussed above, in some embodiments, the analysis of the performance data may be performed using a machine learning model included in the DTC 104. For example, as described above, the performance data of the plurality of cellular networks may be provided to the machine learning model, which can be trained to classify each cellular network 110, 112, 114, 116 (e.g., as best, better, good, poor, or best effort), or trained to identify one of the cellular networks 110, 112, 114, 116 for selection by the DTC 104. The priority identified for each application 108 at block 306 can also be considered by the DTC 104 in addition to the performance data to determine or select a cellular network for each application 108. For example, the priority identified for each application 108 may be input to the machine learning model or considered by application of the predetermined rules and/or thresholds by the DTC 104.

At block 310, the DTC 104 can transmit a command signal to the AER 102 indicating the selected cellular network for each application 108 (e.g., a policy or policy configuration). Accordingly, the DTC 104 can tell the AER 102 which cellular networks from the plurality of cellular networks 110, 112, 114, 116 to select for each application 108 based on the performance data. Because the individual cellular network was determined based on the performance data, the indicated cellular network may be the best or optimal for the application 108 given present circumstances. In some embodiments, the AER 102 can match the application traffic for an application 108 to the cellular network selected or identified by the DTC 104 based on the command (or policy configuration) provided by the DTC 104.

At block 312, the AER 102 can transmit data and information (e.g., video data, GPS data, scanning data, etc.) from each application 108 over the appropriate selected cellular network for each application. In some embodiments, the AER 102 can transmit data from one or more of the applications 108 to a fleet management system 118.

Accordingly, through the process of FIG. 3, for example, the DTC 104 can advantageously distribute or steer traffic and load across the cellular networks 110, 112, 114, 116 dynamically based on at least the performance data for each cellular network 110, 112, 114, 116 supported by the AER 102. In some embodiments, if all of the cellular networks 110, 112, 114, 116 are operable and meet SLAs or defined KPIs, all of the cellular networks 110, 112, 114, 115 may be in use simultaneously at any given time. The DTC 104 advantageously provides an on-demand data traffic controller that can manage an AER 102 (e.g., each AER 102 in a fleet) and provide dynamic policies to the AER 102. Advantageously, in some embodiments, the DTC 104 can make routing and data traffic steering decisions automatically with no human or manual intervention.

In some embodiments, one DTC 104 may be used to control data traffic for each of a plurality of mobile entities 106 in a fleet. For example, each AER 102 of the mobile entities 106 in the fleet may provide cellular network performance data to the DTC 104, and the DTC 104 may execute the process of FIG. 3 with respect to each AER 102 and its corresponding cellular network performance data. Each AER 102 may, as a result receive a respective policy transmitted by the DTC 104 specifying the cellular network to use for each application of that AER 102. Thus, the DTC 104 can distribute or steer traffic and load across the cellular networks 110, 112, 114, 116 for each AER 102 of each mobile entity 106 of the feet.

To illustrate an example of the process 300 being executed, in a first coverage area, an AER 102 of a mobile entity 106 may be transmitting application data (e.g., in block 312) implementing a first policy provided from a DTC 104 (e.g., in block 310) that indicated which cellular network 110, 112, 114, 116 to use (i.e., select) for each application 108. For example, in accordance with the first policy the AER 102 may transmit: 1) data from an application with a highest priority (e.g., a security surveillance application) over a first cellular network 110 with a “Best” classification (i.e., as determined by the DTC 104) at the current point in time, 2) data from an application with a second highest priority (e.g., a driver monitoring application) over a second cellular network 112 with a “Better” classification at the current point in time, 3) data from an application with a third highest priority (e.g., a real time asset management application) over a third cellular network 114 with a “Good” classification at the current point in time, and 4) data from an application with a lowest priority (e.g., a vehicle diagnostics application) over a fourth cellular network 116 with a “Best Effort” classification at the current point in time. Then, when the mobile entity 106 moves from the first coverage area to a second coverage area, and the process of FIG. 3 is executed again, the performance data for one or more of the cellular networks 110, 112, 114, 116 can change between the first coverage area and the second coverage area. For example, in the second coverage area, the performance data for one or more of the cellular networks 110, 112, 114, 116 may be above or below a predetermined threshold (i.e., minimum and maximum thresholds). For example, in the second coverage area the latency of the first cellular network 110 may exceed a threshold and the delay of the first cellular network 110 may exceed a threshold and the DTC 104 may determine that the first cellular network 110 should now be classified as “Best Effort” based on its current performance data in the second coverage area. In addition, in this example, the performance data for the fourth cellular network 116 may improve (e.g., lower latency, less network congestion) such that the DTC 104 may determine that the fourth cellular network 116 should now be classified as “Best” based on its current performance data in the second coverage area. Accordingly, the DTC 104 can generate and transmit to the AER 102 a second policy (e.g., through executing blocks 302-310) indicating that the fourth cellular network 116 should be selected for the highest priority application of the mobile entity 106 (e.g., the security surveillance application) and the first cellular network 110 should be selected for the lowest priority application of the mobile entity (e.g., the vehicle diagnostics application). In this example, the classification determined by the DTC 104 for the second cellular network 112 and the third cellular network 114 does not change based on the performance data for these cellular networks in the second coverage area and the second policy indicates that the second cellular network 112 can be selected for the application with the second highest priority (e.g., the driver monitoring application) and the third cellular network 114 can be selected for the application with the third highest priority (e.g., the real time asset management application). In other examples, however, the classifications of the cellular networks 112, 114 could change and the second policy may be updated to select different cellular networks for these applications as well. Upon receipt of the second policy, the AER 102 may transmit application data for each application in accordance with the second policy (e.g., in block 312).

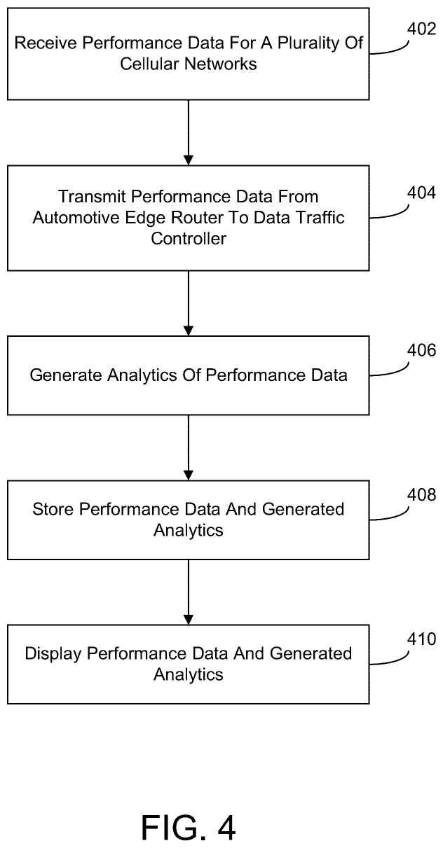

FIG. 4 illustrates a method for providing dynamic analytics for a plurality of cellular networks associated with a mobile entity in accordance with an embodiment. The process illustrated in FIG. 4 is described as being carried out by the system 100 illustrated in FIG. 1, however, in some examples, the process of FIG. 4 may be implemented by another system. Although the blocks of the process are illustrated in a particular order, in some embodiments, one or more blocks may be executed in a different order than illustrated in FIG. 4, or may be bypassed.

At block 402, an AER 102 can receive performance data for a plurality of cellular networks (e.g., cellular networks 110, 112,114, 116) connected to and in communication with the AER 102. The AER 102 can be configured to provide multi-CSP connectivity, namely, the AER 102 can connect to a plurality of cellular networks 110, 112, 114, 116, where each cellular network is associated with a different CSP or carrier. The AER 102 can be configured to receive performance data from each cellular network 110, 112, 114, 116. In some embodiments, the performance data for each cellular network can include, for example, signal strength (coverage), network congestion, latency, data volume allowed uplink and downlink, jitter, delay, type of radio access technology (e.g., 4G, 5G), etc. Advantageously, performance data can be received by the AER 102 from each cellular network 110, 112, 114, and 116 in real-time or substantially real-time.

At block 404, the AER 102 can transmit the performance data for each cellular network 110, 112, 114, 116 to a DTC 104 using, for example, one of the cellular networks 110, 112, 113, 116 connected to the AER 102. In some embodiments, the AER 102 can transmit the performance data to the DTC 104 continuously and in real-time. As mentioned above, in some embodiments, the AER 102 can transmit the performance data of each cellular network to the DTC 104 automatically and continuously, for example, using a push-based mechanism (e.g., streaming telemetry), and via one of the cellular networks 110, 112, 114, 116.

At block 406, the DTC 104 can generate analytics from the performance data for each cellular network 110, 112, 114, 116. In some embodiments, the analytics can include, for example, usage metrics, fault and log data, etc.

At block 408, the performance data and/or the generated analytics may be stored in a memory of the DTC 104, for example memory 510 shown in FIG. 5. In some embodiments, the performance data and the generated analytics can be associated with identifying information such as, for example, time stamps, location of the mobile entity 106 when the data was generated, identifier of the mobile entity 106, etc.

At block 410, the performance data and/or the generated analytics may be displayed on a display, for example display 504 shown in FIG. 5 or on a display associated with the fleet management system 118. An optional interface, for example, an API 120 may be provided to allow an operator of the fleet management system 118 to access and view the performance data and generated analytics of the DTC 104. For example, the operator may transmit requests for the performance data and generated analytics via a computer interface of the fleet management system 118 to the API 120. The API 120 may receive the requests, interface with the DTC 104 to retrieve data in accordance with the requests, and provide the retrieved data to the fleet management system 118. In some embodiments, an operator of the fleet management system 118 may use the performance data and analytics to, for example, evaluate the service provided by a CSP or for traffic route planning. In an example, an operator of the fleet management system can use the performance data and analytics accessible from the DTC 104 to understand the performance of the fleet vehicles (e.g., is the connectivity in a first fleet vehicle working versus the connectivity in a second fleet vehicle), and what cellular network 110, 112, 114, or 116 is providing consistently the best connectivity. In some embodiments, the analytics can include dashboards, usage metrics, fault and log data, etc.

As mentioned above with respect to FIG. 1, the DTC 104 and API 120 shown in FIG. 1 may be implemented on a computer system (e.g., a server). FIG. 5. is a block diagram of an example computer system in accordance with an embodiment. The computer system 500 (e.g., a server) may include one or more processor devices 502, a display 504, one or more inputs 506, one or more communication systems 508, and memory 510. In some embodiments, processor device(s) 502 can be any suitable hardware processor or combination of processors, such as a CPU, a GPU, an LPU, an ASIC, an FPGA, etc. The processor device(s) 502 may include one or more processor, processor cores, processing elements, processor clusters, or other electronic processing units. Accordingly, a processing function described as being performed by the processor device(s) 502 may include multiple processors, processor cores, processing elements, processing clusters, etc. (of the processor device(s) 502) performing aspects or portions (sub-functions) of the processing function to complete the processing function. The one or more electronic processing units of the processor device(s) 502 my include one or more microprocessors, application-specific integrated circuits (“ASICs”), or other suitable electronic device for processing data. At least in some examples, the one or more electronic processing units of the processor device(s) 502 can be co-located physically (e.g., in the same facility, building, room, rack, or computing housing) as part of the computer system 500.

In some embodiments, display 504 can include any suitable display devices, such as a computer monitor, a touchscreen, a television, etc. In some embodiments, display 504 can be omitted. In some embodiments, inputs 506 can include any suitable input devices and/or sensors that can be used to receive user input, such as a keyboard, a mouse, a touchscreen, a microphone, etc. In some embodiments, inputs 506 can be omitted.

In some embodiments, communications system(s) 508 can include any suitable hardware, firmware, and/or software for communicating information over any suitable communication network (e.g., one or more of cellular networks 110, 112, 114, 116 shown in FIG. 1). For example, communication system(s) 508 can include one or more transceivers, one or more communication chips and/or chip sets, etc. In a more particular example, communication system(s) 508 can include hardware, firmware and/or software that can be used to establish a Wi-Fi connection, a Bluetooth connection, a cellular connection, an Ethernet connection, etc.

In some embodiments, memory 510 can include any suitable storage device or devices that can be used to store instructions, values, etc., that can be used, for example, by processor device 502 to present content using display 504, to communicate with an AER 102 (shown in FIG. 1), a fleet management system 118 (shown in FIG. 1), etc. Memory 510 can include any suitable volatile memory, non-volatile memory, storage, or any suitable combination thereof. For example, memory 510 can include RAM, ROM, EEPROM, eMMC, one or more flash drives, one or more hard disks, one or more solid state drives, one or more optical drives, etc. The memory 510 may store data and/or instructions for use and execution by the computer system 500 (e.g., by the processor device(s) 502) to implement the functionality of, for example, the DTC 104 and API 120 described herein. For example, the memory 510 may include or store the DTC 104 or the API 120, both shown in FIG. 1. In some embodiments, the functionality described herein as being performed by the computer system 500 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.

Certain operations of methods according to the technology, or of systems executing those methods, can be represented schematically in the FIGS. or otherwise discussed herein. Unless otherwise specified or limited, representation in the FIGS. of particular operations in particular spatial order can not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for dynamic edge routing of data traffic for a mobile entity having an automotive edge router and a plurality of applications, the system comprising:
a memory that stores one or more computer readable media that include instructions; and
one or more processor devices configured to execute the instructions of the computer readable media to:
receive performance data for a plurality of cellular networks from the automotive edge router;
select one of the plurality of cellular networks for each application of the plurality of applications on the mobile entity based on the performance data for the plurality of cellular networks; and
transmit a command signal to the automotive edge router indicating the selection of one of the plurality of cellular networks for each application of the plurality of applications.

2. The system according to claim 1, wherein each cellular network is associated with a different communication service provider (CSP).

3. The system according to claim 1, wherein the one or more processor devices are configured to execute the instructions of the computer readable media further to: generate a set of analytics based on the performance data for the plurality of cellular networks.

4. The system according to claim 3, wherein the system further comprises an application programming interface configured to enable access to the performance data and the set of analytics.

5. The system according to claim 1, wherein the mobile entity is a fleet vehicle.

6. The system according to claim 1, wherein the plurality of applications include a video application, an audio application, a location application, an asset management application, and data vehicle monitoring application.

7. The system according to claim 1, wherein the plurality of cellular networks are one or more of a 4G network and a 5G network.

8. The system according to claim 1, wherein the performance data includes one or more of signal strength, network congestion, latency, data volume allowed for uplink and downlink, jitter, and delay.

9. A method for dynamic edge routing of data traffic for a mobile entity having an automotive edge router and a plurality of applications, the method comprising:
receiving, using a data traffic controller, performance data for a plurality of cellular networks;
identifying, using the data traffic controller, a priority for each application of the plurality of applications of the mobile entity;
selecting, using the data traffic controller, a cellular network from the plurality of cellular networks for each application of the plurality of applications based on the performance data; and
transmitting, using the data traffic controller, a command signal to the automotive edge router indicating the selection of one of the plurality of cellular networks for each application of the plurality of applications.

10. The method according to claim 9, wherein each cellular network is associated with a different communication service provider (CSP).

11. The method according to claim 9, further comprising generating, using the data traffic controller, a set of analytics based on the performance data.

12. The method according to claim 11, further comprising generating an application programming interface configured to enable access to the performance data and the set of analytics.

13. The method according to claim 9, wherein the mobile entity is a fleet vehicle.

14. The method according to claim 9, wherein the performance data includes one or more of signal strength, network congestion, latency, data volume allowed for uplink and downlink, jitter, and delay.

15. The method according to claim 9, wherein the performance data is received by the data traffic controller continuously in real-time.

16. The method according to claim 11, further comprising displaying the performance data and the generated set of analytics.

17. An automotive edge router for dynamic edge routing of data traffic for a mobile entity having a plurality of applications, the automotive edge router comprising:
a transceiver configured to transmit and receive signals; and
one or more processor devices coupled to the transceiver and configured to:
connect to and be in signal communication with a plurality of cellular networks,
receive performance data for each of the plurality of cellular networks,
transmit the performance data for each of the plurality of cellular networks to a data traffic controller via one of the plurality of cellular networks,
receive a command signal from the data traffic controller indicating a selection of one of the plurality of cellular networks for each application that is based on the performance data, and
simultaneously transmit information from each application over the cellular network selected for each application.

18. The automotive edge router according to claim 17, further comprising a plurality of SIM cards, wherein each of the plurality of SIM cards corresponds to one of the plurality of cellular networks.

19. The automotive edge router according to claim 17, wherein the one or more processor devices are further configured to receive the performance data for each cellular network continuously in real-time and to transmit the performance data to the data traffic controller continuously and in real-time.

20. The automotive edge router according to claim 17, wherein each cellular network is associated with a different communication service provider (CSP.
